(19) United States
(12) Patent Application Publication
(10) Pub. No.: US 2006/0106683 A1
(43) Pub. Date: May 18, 2006

(54) Customer Specific Catalogs Based on a Set of Standart Catalogs

(75) Inventors: Craig Fisher, Redmond, WA (US); Harlan Edward Husmann, Woodinville, WA (US); Constantin Mihai, Bellevue, WA (US); Vinayak Tadas, Bellevue, WA (US); Gautam Vaidya, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,704

(22) Filed: Jan. 25, 2006

Related U.S. Application Data
(62) Division of application No. 10/157,527, filed on May 28, 2002.

(51) Int. Cl. G06F 17/30

(52) U.S. Cl. 705/27

(57) ABSTRACT

Generating and/or managing customer specific catalogs based on a set of standard catalogs are described. In one aspect, a catalog is generated or managed in view of a catalog schema data structure. The catalog schema data structure includes a first table The first table includes first, second, and third data fields. the first data field indicates a product, category, or variant of a base catalog to include or exclude from a virtual catalog that is derived at least in part from the base catalog. The second data field specifies an inclusion or exclusion rule to apply to the base catalog, product, category, or variant identified in the first data field. The third date if field provides an object ID of the product, category or variant.

### RELATED APPLICATIONS

This application is a divisional of co-pending U.S. patent Ser. No. 10/157,527 filed on May 28, 2002, titled “Systems and Methods for Generating A Customer Specific Catalog from a Base Catalog”, which is hereby incorporated by reference.

### BACKGROUND

To facilitate business opportunities on the Internet, businesses are increasingly using electronic catalogs to promote and sell goods and services. Conventional electronic catalog generation and management systems and techniques allow a business to indicate information that is useful at point-of-sale such as what products and services are for sale and respective pricing information.

A business that wants to market goods and/or services to various different customers in an electronic catalog format typically has to create and maintain multiple independent base catalogs. In general, a base catalog contains specific instances of the particular goods/services, product/service variants, prices, marketing techniques, language(s), etc., that are targeted to a particular audience. To simplify consumer navigation of base catalog contents, the base catalog further typically includes product layout or topology information (i.e., hierarchies and relationship metadata) to assist in category, product, and variant organization and access.

Because individual base catalogs are typically targeted to a particular audience, businesses commonly need to create and maintain multiple independent base catalogs. For instance, retailers typically receive multiple different electronic catalogs from various wholesalers/publishers. Consider that in this situation, a retailer may want to: (a) present only a portion of the products represented in one or more wholesaler/publisher catalogs (e.g., unique product selection); b)) present distinctive pricing; (c) change product organization (i.e., catalog topology); (d) meet specific country/state advertising regulations; and/or (e) otherwise target one or more specific audiences (e.g., particular languages, etc.). In such situations, the retailer must generally create and manage one or more separate base catalogs from portions of one or more wholesaler/publisher catalogs.

These separate base catalogs completely or partially incorporate desired wholesaler/publisher catalog aspects. Each of these separate catalogs may require additional customization (e.g., product navigation topology, pricing, language, etc.) to reflect the particular requirements of targeted audience. Unfortunately, creating and maintaining multiple independent base catalogs across various customer bases, pricing schemes, regulations, etc. is a time consuming, laborious, and expensive process.

The following description addresses these and other limitations of conventional systems and techniques to create and manage electronic base catalog content across multiple diverse target audiences.

### SUMMARY

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

In view of the above, generating and/or managing customer specific catalogs based on a set of standard catalogs are described. In one aspect, a catalog is generated or managed in view of a catalog schema data structure. The catalog schema data structure includes a first table. The first table includes first, second, and third data fields the first data field indicates a product, category, or variant of a base catalog to include or exclude from a virtual catalog that is derived at least in part from the base catalog. The second data field specifies an inclusion or exclusion rule to apply to the base catalog, product, category, or variant identified in the first data field. The third date if field provides an object ID of the product, category or variant

### BRIEF DESCRIPTION OF THE DRAWINGS

The same numbers are used throughout the drawings to reference like features and components.

FIG. 1 shows an exemplary system to generate and manage a virtual catalog.

FIG. 2 shows exemplary relationships of virtual catalogs to base catalogs.

FIG. 3 shows further aspects of an exemplary system of FIG. 1 for virtual catalog generation and management.

FIG. 4 shows an exemplary virtual catalog designer/editor user interface (UI) for generating and editing a virtual catalog.

FIG. 5 shows an exemplary price rules sheet of FIG. 4 for applying pricing rules to elements in a virtual catalog.

FIG. 6 shows an exemplary procedure to generate a virtual catalog from one or more base catalogs.

FIG. 7 shows an example of a suitable computing environment on which an exemplary system and procedure to generate a virtual catalog from one or more base catalogs may be implemented.

### DETAILED DESCRIPTION

Overview

The following description provides for methods, systems, computer-readable media, application program interfaces (APIs), schemas, and so on, to generate and manage electronic customer specific catalogs. Hereinafter, a customer specific catalog is referred to as a “virtual catalog” (VC), because it is a logical representation of catalog content from one or more base catalogs. A VC is a logical representation of base catalog content because the VC incorporates base catalog content by reference, wherein the base catalog(s) includes the specific instances of the VC incorporated content. Because base catalog information is incorporated by reference in the VC, whenever information in the base catalog is modified, removed, or otherwise updated, such updates are automatically reflected in the VC.

An Exemplary System

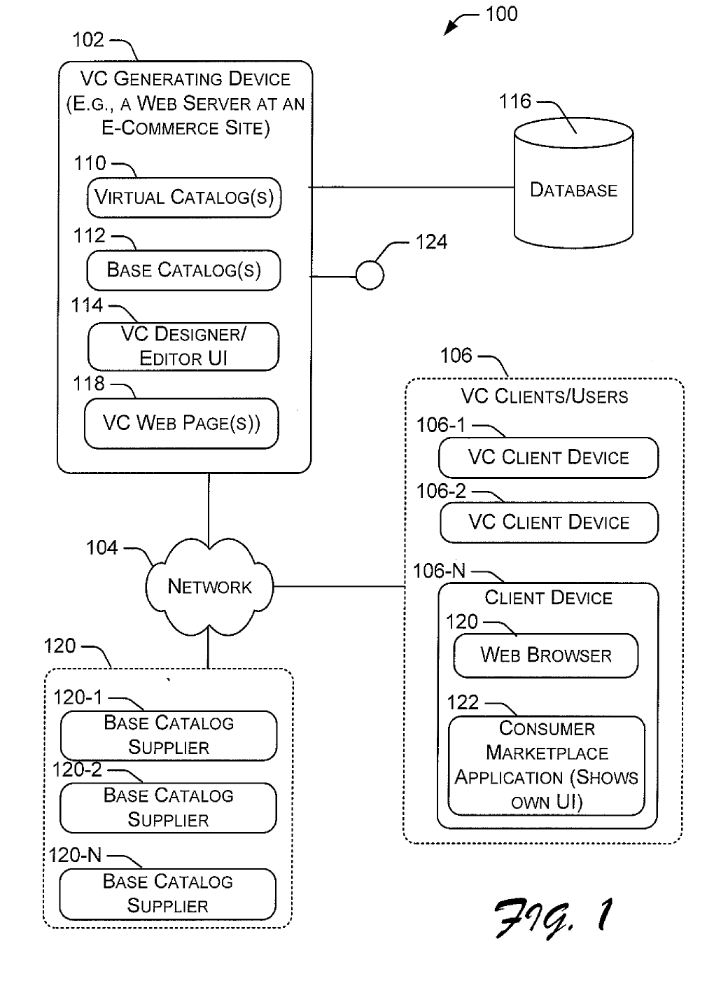

FIG. 1 shows an exemplary system 100 to generate and manage electronic customer specific catalogs. The system 100 includes a VC generating device 102 coupled across a communication path 104 (e.g., an organizational intranet or the Internet) to any number of client devices 106 and to any number of base catalog suppliers 108. As used herein, the VC generating device is any electronic device having data communications, data storage capabilities, and/or functions to generate virtual catalogs (VCs) from any number of catalog sources. In one implementation, for example, the computing device is a Web server for an e-commerce site.

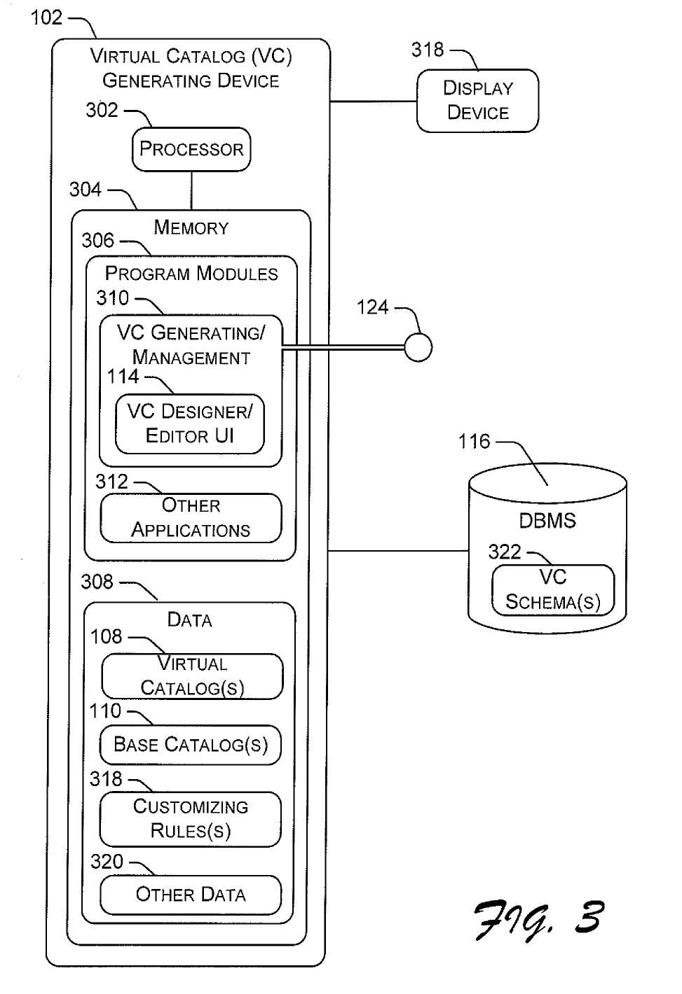

VC generating device 102 generates VC 110 by incorporating/aggregating references to catalog designer specified base catalog 112 content (e.g., products, product categories, pricing information, product hierarchies, and so on) into the VC. In one implementation, a catalog designer specifies content to be referenced in the VC via VC designer/editor user interface (UI) 114. Exemplary aspects of the VC designer/editor are described in greater detail below in reference to FIGS. 3-5.

VC 110 references to base catalog content are not actual instances of base catalog content in the VC. Rather, VC generating device 112 incorporates base catalog 112 content into the VC via one or more embedded Uniform Resource Identifier(s) (URI(s)). A URI is a generic term for all types of names and addresses that refer to objects that may be stored locally or otherwise (e.g., base catalog(s) maintained by a base catalog supplier 108 on the World Wide Web (WWW)). A Universal Resource Locator (URL) is one kind of URI.

Although FIG. 1 shows VC generating device 102 coupled across communication path 104 to catalog supplier(s) 108, this connection is optional because the VC generating device may store some or all of its own data including any number of base catalogs 110 locally or otherwise such as in database 116 (e.g., an SQL database).

VC generating device 102 communicates or serves VC(s) 110 to a client device 106 for presentation. To present a VC, the client device resolves the URI resource referencing mechanism(s) embedded in the VC. These resolved resources can be presented by the client device in a number of different manners. In one implementation, a VC is communicated to client device(s) as Web page 118, which is represented with Hypertext Markup Language (HTML), embedded applets (e.g., java script), and so on, for presentation on a Web browser 120 hosted by receiving client device(s).

In another implementation, client device 106 hosted consumer marketplace application 122 accesses exposed VC API to request VC generating device 102 to communicate VC 110 content to the application for presentation. In this manner, the marketplace application can present VC referenced content in any presentation format desired (e.g., in a presentation format other than the presentation format presented by VC Web page 118). An exemplary VC API is described in greater detail below in reference to the section titled “An Exemplary Virtual Catalog API”.

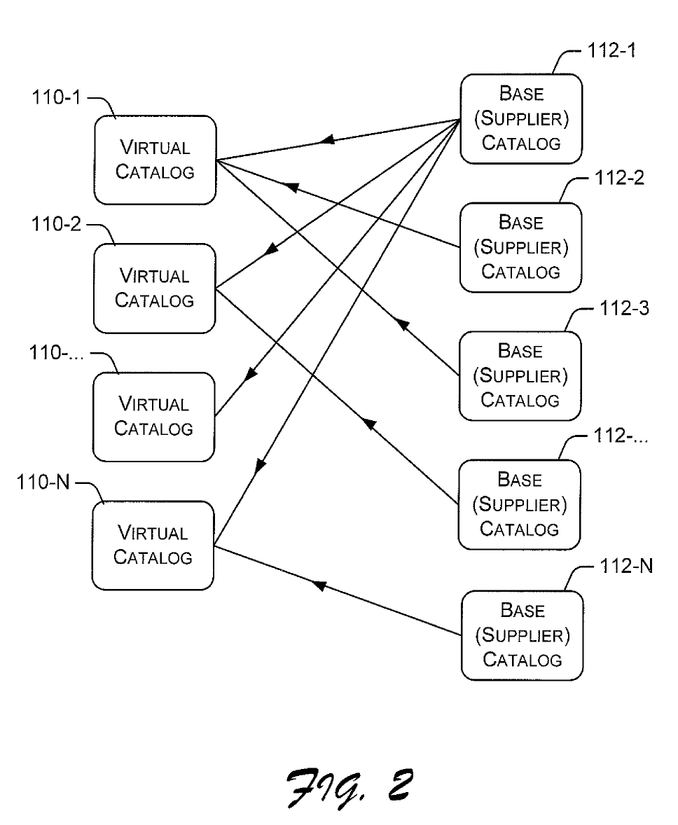

FIG. 2 shows further aspects of an exemplary relationship of VCs 108 of FIG. 1 to base catalogs 112. Virtual catalogs provide for substantial economy of scale because a single base catalog can provide content for multiple virtual catalogs, and a single virtual catalog can reference content from multiple base catalogs. The directional arrows between respective virtual catalogs and base catalogs illustrate incorporation (e.g., by reference or otherwise) of at least a subset of a corresponding base catalog content into one or more respective virtual catalogs. This means that, a single instance of a product, as described in its base catalog, can be incorporated by reference in any number of independent virtual catalogs.

An Exemplary Virtual Catalog Generating Device

FIG. 3 shows further aspects of a virtual catalog (VC) generating device 102 of FIG. 1 to generate, manage, and distribute electronic or virtual catalogs 110 for display and navigation. Each VC generating device 102 is operational as any one of a number of different computing devices such as a personal computer, an image server computer, a thin client, a thick client, a hand-held or laptop device, a multiprocessor system, a microprocessor-based system, a network PC, minicomputer, mainframe computer, and so on.

VC generating device 102 includes processor 302 coupled to system memory 304. System memory 304 includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, and so on.

Processor 302 is configured to fetch and execute computer program instructions from applications or program modules 306 portion of memory 304. Program modules typically include routines, programs, objects, components, and so on, for performing particular tasks or implementing particular abstract data types. While executing computer program instructions from program modules 306 portion of memory 304, processor 302 is configured to fetch data from data 308 portion of the memory. Data includes one or more virtual catalogs 110, one or more base catalogs 112, and/or other data 118 (e.g., configuration information, Web pages 118 of FIG. 1, and so on.).

Program modules 306 include, for example, virtual catalog (VC) generating module 310, and other applications 312 such as an operating system, a Web browser, device drivers, and so on. VC generating module generates, edits, or otherwise maintains one or more VCs 110. VC generating module further imports, exports, and/or exchanges information corresponding to specific VCs and/or base catalogs 112 with other VC generating devices 102, one or more client devices 106 of FIG. 1, and/or one or more base catalog suppliers 108.

A VC can be represented in any of a number of different data formats. For instance, in this implementation, a generated VC is represented in as a markup language data format with customized tags that enable definition, transmission, validation, and interpretation of data (e.g., an Extensible Markup Language (XML) data format).

VC generating module 310 includes a VC designer/editor user interface (UI) 114 for a catalog designer to specify and/or customize the particular information included in VC 110 from any number of base catalogs 112. VC generating module 310 creates VC 110 as it is designed by the catalog designer. The specific information included in any VC is customizable because it can include all base catalog 112 information, or any definable subset of base catalog information, as well as other customized information that is not supplied by the base catalog(s) (e.g., pricing, localization, catalog topology information, and so on).

The UI 114 allows a catalog designer to specify a particular base catalog 112 from which to incorporate content by reference into VC 110. The UI further allows the catalog designer to apply a number of catalog customizing rules 318 to particularly specify the information (e.g., categories, products, variants, topology, etc.) from one or more base catalogs to incorporate into the VC.

For example, VC customizing rules 318 include inclusion and exclusion rules that are used to specifically indicate whether a product, category, variant, or even all of the information in a base catalog 112 is to be referenced in VC 110. Other VC customizing rules include, for instance, pricing rules that are used to particularly indicate item prices in a fashion that is not only completely independent of the particular prices specified in the BC(s), but also in a manner that generates customized item prices based on pricing information in the base catalog(s).

VC generating module 310 stores generated VC(s) 110 into DBMS 116. The DBMS utilizes VC schema 322 to enforce the structure of a DBMS by specifying the specific syntax and structure (e.g., tables, data fields in each table, and relationships between fields and tables) on the newly generated VC.

For example, VC schema 322 elements provide syntactic definitions for creating virtual catalogs 108, adding including/excluding categories to a virtual catalog 110, support for: (a) category definitions (e.g. department, section, etc.); (b) product definitions and/or references (e.g., URIs to the product definitions, shirt, book, etc.); (c) property definitions(e.g., name, image height, image width, description, etc.); (d) inclusion/exclusion rules (rules to include an entire base catalog, or include/exclude a category, or include/exclude a certain product); pricing and currency rules (e.g., percentage adjustment on a list price, an exact amount or “fixed price” to increase or decrease from a list price, or setting the exact price of the product); (e) support for a primary parent category; (f) support for materializing a virtual catalog 110 for enhanced performance; (g) localization and/or multi-language support; (h) support for importing base catalogs 110 and/or virtual catalogs 108 across any number of data formats (e.g., XML, CSV etc), etc.

TABLES 1-5 show exemplary aspects of VC schema 322 tables for specifying and designing VC 110. Angle brackets <and > are used to distinguish VC schema syntax rule names (syntactical components) in TABLES 1-5. Descriptions of syntactical components are provided in the adjacent table column titled “Description”. Each syntactical component has a corresponding data type (not shown) such as integer (e.g., OID, Rule Type, etc.), money (e.g., “Amount”, etc.), character (e.g., catalog name, etc.), and so on. VC schema syntax rules include at least the following combinations of syntactical components illustrated in TABLES 1-5.

TABLE 1
Included Products and Categories Table
Virtual Catalog: Included Products and Categories Table

| Column | Description |
|---|---|
| <Catalog Name> | Name of the catalog product or category |
| <Type> | Type of rule (i.e., inclusion or exclusion) |
| <OID> | OID of the catalog or product or category or variant |
| (object ID) | A product-family, e.g., can be a “505 model” jeans |
| | with a price property = $40, a manufacturer |
| | property = 505, etc. |
| | A variant, for example, may be a “505 model” jean in |
| | X-Large size in blue color (it could have a variantID |
| | of XL-Green). |

TABLE 2
Virtual Products Table
Virtual Products Table

| Column | Description |
|---|---|
| <Base Catalog | Base catalog name |
| Name> | |
| <Base Catalog | OID in the base catalog |
| OID> | |
| <List Price> | Evaluated list price |

TABLE 3
Hierarchy Table
Hierarchy Table

| Column | Description |
|---|---|
| <OID> | Unique ID |
| <Catalog Name> | Catalog name |
| <Child OID> | Unique ID of child |
| <Child Catalog | Catalog name |
| Name> | |
| <fVirtualCatalog> | Indicates whether this hierarchy link was inherited |
| | from a BC or newly defined in the VC. |

TABLE 4
Pricing Rules Table
Pricing Rules Table

| Column | Description |
|---|---|
| <Catalog Name> | Catalog name from which this rule is derived |
| <OID> | The OID of the catalog, category, product, variant to |
| | which this rule applies |
| <Rule Type> | Percentage on/off, fixed on/off, set amount, no- |
| | change. |
| <Amount> | Used with adjustment type to determine new price |

TABLE 5
Relationships Table
Relationship Table

| Column | Description |
|---|---|
| <From_CatalogName> | Source catalog name |
| <from_oid> | Oid of the source category or product |
| <To_CatalogName> | Target catalog name |
| <to_oid> | Oid of the target category or product |
| <fVirtualCatalog> | Specified if this relationship was |
| | inherited from base catalog or explicitly |
| | added in the virtual catalog |
| <Name> | Name of the relationship |

An Exemplary Virtual Catalog Generation/Management UI

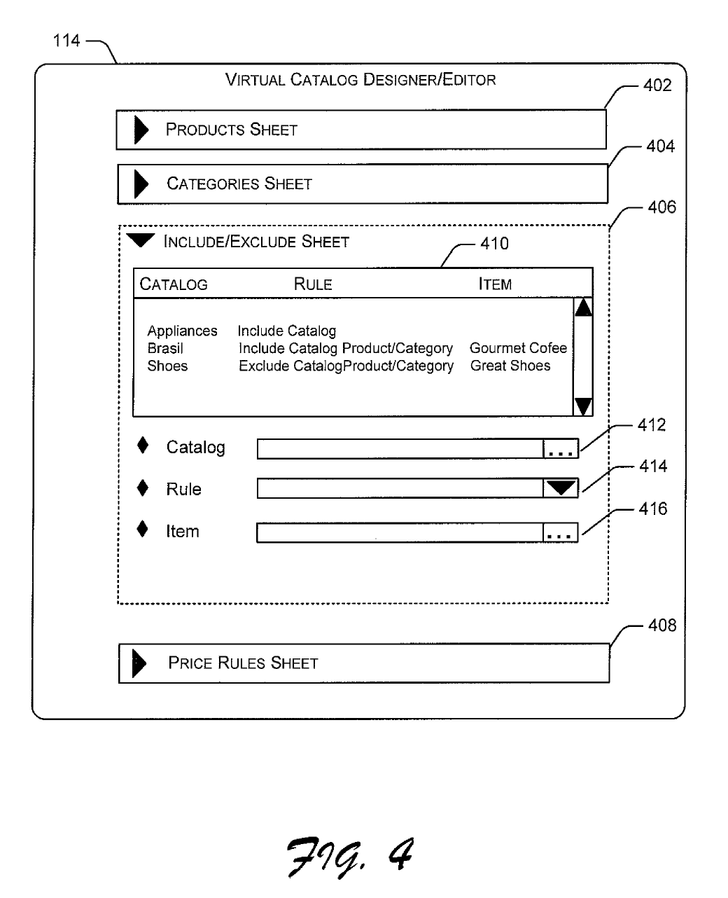

FIG. 4 shows an exemplary virtual catalog designer/editor UI 114 for generating and editing a virtual catalog 110. The UI 114 includes, for example, a products sheet 402, a categories sheet 404, an include/exclude sheet 406, and a price rules sheet 408. The products sheet 402 is for the management of products corresponding to the virtual catalog as the result of applying the set of inclusion/exclusion rules which currently define the virtual catalog. The products sheet allows the user to retrieve/display products using keyword search or search by properties features. The products sheet also exposes entry points (button controls) to another piece of user interface: the Product Editor which provides means to edit the product information including its category assignment and product relationships in either the context of product's base catalog or in the context of the current virtual catalog.

The categories sheet 404 is for the management of categories corresponding to the virtual catalog as the result of applying the set of inclusion/exclusion rules which currently define the virtual catalog. The categories sheet provides means to navigate the virtual catalog's categories hierarchy in a tree-like manner and also to retrieve/display the products associated with the current category selection in the tree view. The categories sheet exposes entry points (button controls) to another piece of user interface: the Category Editor which allows the user to add either a new category or edit an existing category instance. The categories sheet also provides features to remove the current category selection if and only if the category belongs to the virtual catalog itself and it does not represent an inclusion rule. The categories sheet also exposes entry points to the Product Editor UI allowing the user to edit a currently selected product (corresponding to the currently selected category in tree view) either in the context of its base catalog or in the context of the virtual catalog. The product information which could make the subject of an edit operation includes the product's category assignment and product relationships besides product type's specific attributes.

The include/exclude sheet 406 provides the catalog designer with the opportunity to include or exclude information from a specific base catalog 110. Specifically, the catalog designer uses aspects of the include/exclude sheet 406 to apply various combinations of inclusion and/or exclusion rules322 1 to contents of a base catalog 110 at catalog, category, product or variant and category levels. Products or categories or variants of a particular base catalog 110 which are “included” are incorporated by reference into a particular virtual catalog 11 0. Products or categories or variants of the particular base catalog which are “excluded” are not incorporated by reference into the particular virtual catalog 110.

The include/exclude sheet 406 includes, for example, information viewing area 410, a catalog browse button 412 to expose a select catalog dialog box, a rule select field 414 to present include catalog, include catalog product/category, and exclude catalog product/category options for user selection, and an item browse button 416 to present a product/category picker dialog box (corresponding to the selected catalog).

Additionally, the VC designer/editor module 318, provides (via use of virtual catalog API 124) for unambiguous inclusion and exclusion rule evaluation behavior by applying rule precedence criteria to evaluation of the inclusion and exclusion rules. In particular, excluding particular information from a specific base catalog 10 in the virtual catalog 110 will override any subsequent inclusion of the particular information into virtual catalog 110. Virtual catalog 110 rules can be evaluated at any time. However, evaluating the rules at design time may maximize run-time performance and possibly minimize database 118 storage requirements.

Moreover, by applying the inclusion/exclusion rules of the include/exclude sheet 406 to elements of one or more base catalogs to generate a specific virtual catalog 110, the specific virtual catalog 110 can be: (1) designed to inherit a base catalog's 110 particular product organization and/or navigation hierarchy (also referred to as product taxonomy); or, (2) designed with a completely different product organization and/or navigation hierarchy as compared to that provided by the base catalog 112. A Virtual Catalog can inherit a base catalog's taxonomy and also override and define its own taxonomy.

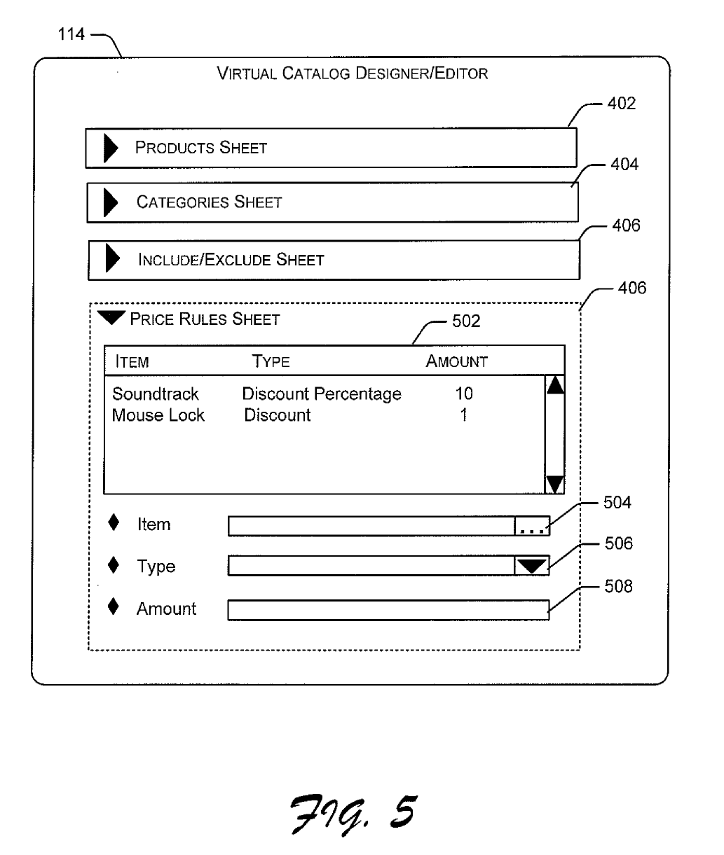

FIG. 5 shows further aspects of the virtual catalog designer/editor UI 114 of FIG. 4. More particularly, FIG. 5 shows further aspects of the price rules sheet 408 of FIG. 4 for applying pricing rules to elements in a virtual catalog 110. The price rules sheet 408 includes, for example a catalog item, type, and amount viewing area 502, an item browse button 504 to present a product/category picker dialog box (not shown), a type select data field 506, and an amount data field for entering a numeric price for a product. The type select data field 506 allows the virtual catalog designer to select the following product pricing options: set price, add to list price, add percentage to list price, discount list price, discount percentage based on the list price, and no pricing change. The viewing area 502 displays the particular items, types, and amounts based on the particular information selected and/or entered by the virtual catalog designer from data fields 504 through 508.

With respect to the no-change price rule, consider, for example, the following hierarchy, wherein A is a parent to B and B is a parent of C. To discount A and B by 10%, but not change C's price, the following price rules are specified:
A (a percentage off (10%) price rule);
   B; and
      C (a no-change price rule).

Pricing rules are applied based on the following criteria:
a price rule is applied to a given element and all its descendents unless overridden by a more-specific price rule;
a price rule that is applied to a given element either is its own price rule or that of its closest ancestor (e.g., in this example, if C didn't have a price rule, but both A and B had price rules, then C would apply B's price rule); and
if there is parent ambiguity with respect to an element (i.e., an element has 2 or more parents), then the element is assigned a primary parent from which it may inherit a pricing rule.

Accordingly, the VC UI 114 of FIGS. 4 and 5 allow a catalog designer to generate, maintain, and customize the content of a virtual catalog 110 from at least a subset of the information in one or more base catalogs 110.

An Exemplary Virtual Catalog API

The primary component to build virtual catalogs 108 is the VC generating module 310 of FIG. 3. However, functionality exposed by the VC generating module can also be accessed programmatically via the virtual catalog API (VCAPI) 124. Specifically, the VC API 124 provides for the design/creation and maintenance of virtual catalogs 108 based on one or more base catalogs 110.

The VC API 124 includes, for example, the following interfaces:
a create catalog interface including a parameter to indicate that a virtual catalog is to be created (in contrast to a standard or base catalog 110);
an add virtual catalog rule interface to add a catalog or product, category, or variant, inclusion or exclusion rule into the virtual catalog 110;
a remove virtual catalog rule interface to remove a catalog or product, category, or variant inclusion or exclusion rule from the virtual catalog 110;
a get virtual catalog rule(s) interface to retrieve any catalog or product, category, or variant rules that are included in the virtual catalog 110;
a rebuild virtual catalog interface to rebuild the virtual catalog 110 or rebuild any dependent child virtual catalogs 108 (the virtual catalog 110 being rebuilt by reevaluating all inclusion and exclusion rules, reevaluating all pricing rules, and re-creating any virtual catalog views and/or tables); A virtual catalog view is a union of joins between information in a corresponding virtual products table (i.e., TABLE 3) and the base catalog 112 view. It incorporates by reference the inherited data from the base catalog, the overridden data in the virtual catalog 110 and the exact content based on the VC inclusion/exclusion rules 318.
a remove price rule interface to remove a custom price rule from the virtual catalog 110;
an add price rule interface to add a custom price rule for a catalog or product or category or variant in the virtual catalog 10, wherein the custom price rule corresponds to a percentage on/off of a specified list price, a constant currency amount on/off the specified list price, or an indication to set the list price to a specific currency amount; or an indication to preserve the original list price; and
a get price rule(s) interface to return to record set of any custom price rules for catalog or product, category, or variant rules that are included in the virtual catalog 110.
   An Exemplary Procedure to Generate/Manage a Virtual Catalog

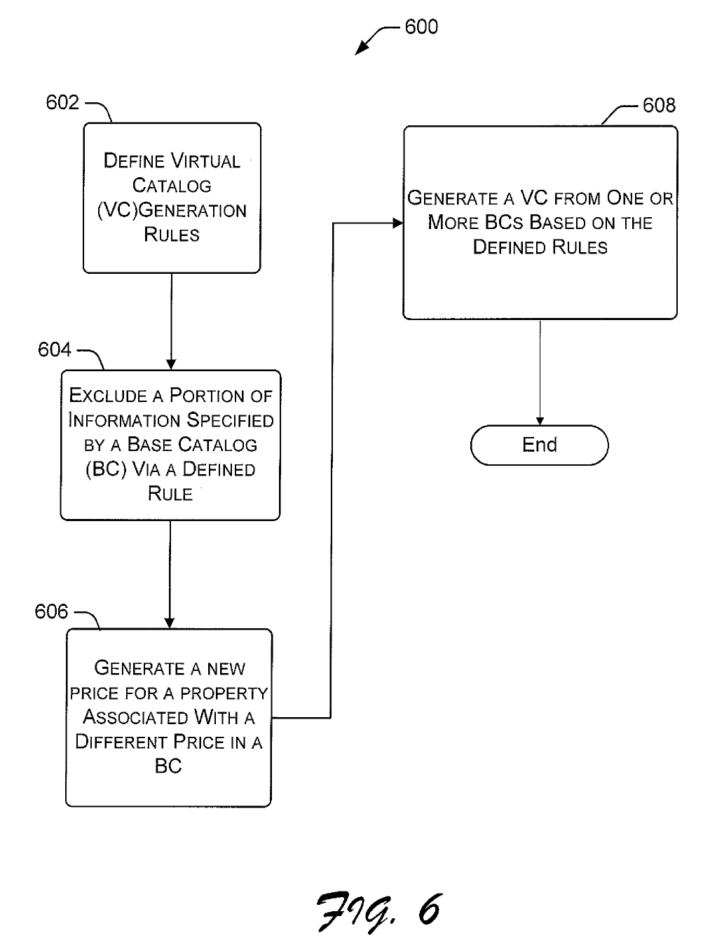

FIG. 6 shows an exemplary procedure 600 to generate and/or manage a virtual catalog 110 from one or more standard or base catalogs 110. At block 602, the virtual catalog generating module (VC generating) 310 indicates or defines a set of rules (i.e., customizing rules 318) that correspond to generation of the virtual catalog. The rules include inclusion, exclusion, and/or pricing rules. At block 604, the VC generating module 310 indicates that a rule of the rules excludes at least a portion of information specified by the one or more base catalogs 110. At block 606, the VC generating module 310 generates a new price based on a rule of the rules for a property of a catalog 110 of the base catalogs 110. The property is associated with a price (e.g., a list price) in the base catalog 110.

At block 608, the VC generating module 310 applies the rules (block 602) to one or more base catalogs to generate the virtual catalog 110 such that the virtual catalog 110 incorporates by reference at least a subset of information specified by the one or more base catalogs 110. This operation 610 includes, for example, representing the property in the new price (block 606) in the virtual catalog 110.

At block 610, the VC generating module 310 communicates at least a subset of information in the virtual catalog 110 to a client device 106 for presentation (e.g., for presentation on a display device, as audio, etc.). For instance, communicated virtual catalog 110 information may be incorporated into a Web page 118 for presentation in a Web browser 120 that is executing at the client device 106. Additionally, communicated virtual catalog 110 information may be forwarded to the client device 106 for presentation in a user interface with characteristics that are specified or customized by the client device 106.

An Exemplary Computing Environment

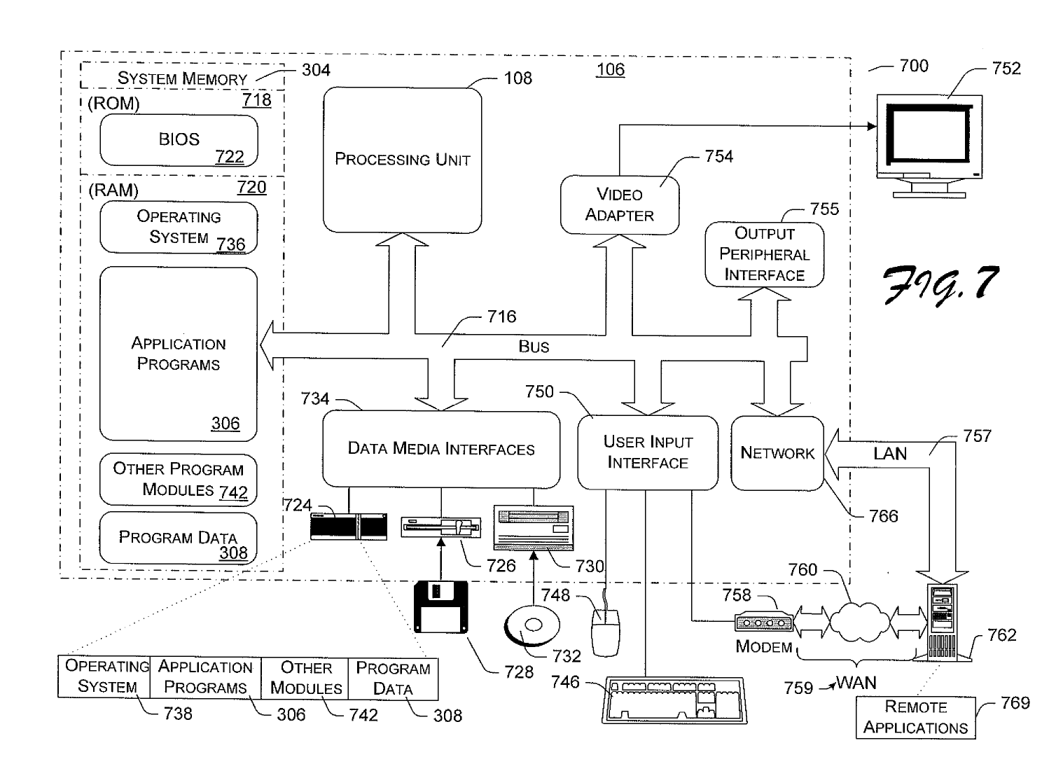

FIG. 7 shows an example of a suitable computing environment 700 on which an exemplary system and procedure to generate/manage a virtual catalog from one or more standard or base catalogs may be implemented. Exemplary computing environment 700 is only one example of a suitable computing environment and is not intended to suggest any limitation as to the scope of use or functionality of an exemplary system and procedure to cluster queries. The computing environment 700 should not be interpreted as having any dependency or requirement relating to any one or combination of components illustrated in the exemplary computing environment 700.

An exemplary system and procedure to generate/manage a virtual catalog from one or more standard or base catalogs may be described in the general context of computer-executable instructions, such as program modules, being executed by a computer. Generally, program modules include routines, programs, objects, components, data structures, etc., that perform particular tasks or implement particular abstract data types. An exemplary system and procedure to generate and manage virtual catalogs 108 may also be practiced in distributed computing environments where tasks are performed by remote processing devices that are linked through a communications network. In a distributed computing environment, program modules may be located in both local and remote computer storage media including memory storage devices.

As shown in FIG. 7, the computing environment 700 includes a general-purpose computing device in the form of a computer 102 of FIGS. 1 and 3. The components of computer 102 may include, but are not limited to, one or more processors or processing units 302, a system memory 304, and a bus 716 that couples various system components including the system memory 304 to the processor 302.

Bus 716 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 102 typically includes a variety of computer-readable media. Such media may be any available media that is accessible by the computer 102, and it includes both volatile and non-volatile media, removable and non-removable media. For example, the system memory 304 includes computer readable media in the form of volatile memory, such as random access memory (RAM) 720, and/or non-volatile memory, such as read only memory (ROM) 718. A basic input/output system (BIOS) 722, containing the basic routines that help to transfer information between elements within computer 102, such as during start-up, is stored in ROM 718. RAM 720 typically contains data and/or program modules that are immediately accessible to and/or presently be operated on by processor 302.

Computer 102 may further include other removable/non-removable, volatile/non-volatile computer storage media. By way of example only, FIG. 7 illustrates a hard disk drive 724 for reading from and writing to a non-removable, non-volatile magnetic media (not shown and typically called a “hard drive”), a magnetic disk drive 726 for reading from and writing to a removable, non-volatile magnetic disk 728 (e.g., a “floppy disk”), and an optical disk drive 730 for reading from or writing to a removable, non-volatile optical disk 732 such as a CD-ROM, DVD-ROM or other optical media. The hard disk drive 724, magnetic disk drive 726, and optical disk drive 730 are each connected to bus 716 by one or more interfaces 734.

The drives and their associated computer-readable media provide nonvolatile storage of computer readable instructions, data structures, program modules, and other data for computer 102. Although the exemplary environment described herein employs a hard disk, a removable magnetic disk 728 and a removable optical disk 732, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 728, optical disk 732, ROM 718, or RAM 720, including, by way of example, and not limitation, an OS 738, one or more application programs 306, other program modules 742, and program data 308. Each such OS 738, one or more application programs 306, other program modules 742, and program data 308 (or some combination thereof) may include an embodiment of an exemplary system and procedure to generate/manage a virtual catalog from one or more standard or base catalogs.

A user may enter commands and information into computer 102 through input devices such as keyboard 746 and pointing device 748 (such as a “mouse”). Other input devices (not shown) may include a microphone, joystick, game pad, satellite dish, serial port, scanner, or the like. These and other input devices are connected to the processing unit 302 through a user input interface 750 that is coupled to bus 716, but may be connected by other interface and bus structures, such as a parallel port, game port, or a universal serial bus (USB).

A monitor 752 or other type of display device is also connected to bus 716 via an interface, such as a video adapter 754. In addition to the monitor, personal computers typically include other peripheral output devices (not shown), such as speakers and printers, which may be connected through output peripheral interface 755.

Computer 102 may operate in a networked environment using logical connections to one or more remote computers, such as a remote computer 762. Logical connections shown in FIG. 7 are a local area network (LAN) 757 and a general wide area network (WAN) 759. Such networking environments are commonplace in offices, enterprise-wide computer networks, intranets, and the Internet. Remote computer 762 may include many or all of the elements and features described herein relative to computer 102.

When used in a LAN networking environment, the computer 102 is connected to LAN 757 via network interface or adapter 766. When used in a WAN networking environment, the computer typically includes a modem 758 or other means for establishing communications over the WAN 759. The modem 758, which may be internal or external, may be connected to the system bus 716 via the user input interface 750 or other appropriate mechanism.

Depicted in FIG. 7 is a specific implementation of a WAN via the Internet. Computer 102 typically includes a modem 758 or other means for establishing communications over the Internet 760. Modem 758, which may be internal or external, is connected to bus 716 via interface 750.

In a networked environment, program modules depicted relative to the personal computer 102, or portions thereof, may be stored in a remote memory storage device. By way of example, and not limitation, FIG. 7 illustrates remote application programs 769 as residing on a memory device of remote computer 762. The network connections shown and described are exemplary and other means of establishing a communications link between the computers may be used.

Computer Readable Media

An implementation of exemplary subject matter to generate/manage a customer specific catalog from one or more standard or base catalogs may be stored on or transmitted across some form of computer-readable media. Computer-readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Conclusion

The described arrangements and procedures provide for the generation and management a virtual catalog 110 from one or more standard or base catalogs 110. Although the arrangements and systems for the generation and management a customer specific catalog 110 from one or more standard or base catalogs 110 have been described in language specific to structural features and methodological operations, it is to be understood that the arrangements and procedures as defined in the appended claims are not necessarily limited to the specific features or operations described. Rather, the specific features and operations are disclosed as preferred forms of implementing the claimed subject matter.

1. A computer-readable medium including computer-program instructions executable by a processor, the computer-program instructions comprising instructions for generating or managing a catalog with a catalog schema data structure, the catalog schema data structure including a first table, the first table comprising:
a first data field indicating a product, category, or variant of a base catalog to include or exclude from a virtual catalog that is derived at least in part from the base catalog;
a second data field specifying an inclusion or exclusion rule to apply to the base catalog, product, category, or variant identified in the first data field; and
a third data field providing an object ID of the product, category or variant.

2. The computer-readable medium of claim 1, wherein the catalog schema data structure further comprises a second table comprising a first data field providing a reference to any dependent virtual catalog that depends on the base catalog, a dependent virtual catalog being referenced in the virtual catalog.

3. The computer-readable medium of claim 1, wherein the catalog schema data structure further comprises a third table comprising:
a first data field identifying the base catalog;
a second data field providing an object ID corresponding to an object indicated by the base catalog; and
a third data field indicating an evaluated list price for the object.

4. The computer-readable medium of claim 1, wherein the catalog schema data structure further comprises a fourth table to represent a catalog taxonomy comprising:
a first data field indicating a substantially unique identification to assign to respective objects in the base catalog;
a second data field providing a catalog name of the base catalog;
a third data field identifying a unique child ID of a child product, category, or variant;
a fourth data field specifying a child catalog name; and
wherein the substantially unique identification, the catalog name, the unique child ID, and a child catalog name, indicate a product hierarchy in the virtual catalog.

5. The computer-readable medium of claim 1, wherein the catalog schema data structure further comprises a fifth table for indicating pricing rules, the fifth table comprising:
a first data field for indicating a catalog name corresponding to a particular rule;
a second data field indicating an object ID of a catalog, category, product, or variant to which the particular rule applies;
a third data field identifying a rule type; and
a fourth data field specifying an amount to determine a new price for the catalog, category, product, or variant.

6. The computer-readable medium of claim 5, wherein the rule type comprises a percentage on/off rule, a fixed on/off rule, a set amount rule, or a no-change rule.

7. The computer-readable medium of claim 5, wherein the new price is based on a list price indicated in the base catalog.

8. A computer-implemented method comprising:
generating or managing a catalog with a catalog schema data structure, the catalog schema data structure including a first table, the first table comprising:
a first data field indicating a product, category, or variant of a base catalog to include or exclude from a virtual catalog that is derived at least in part from the base catalog;
a second data field specifying an inclusion or exclusion rule to apply to the base catalog, product, category, or variant identified in the first data field; and
a third data field providing an object ID of the product, category or variant.

9. The method of claim 8, wherein the catalog schema data structure further comprises a second table comprising a first data field providing a reference to any dependent virtual catalog that depends on the base catalog, a dependent virtual catalog being referenced in the virtual catalog.

10. The method of claim 8, wherein the catalog schema data structure farther comprises a third table comprising:
a first data field identifying the base catalog;
a second data field providing an object ID corresponding to an object indicated by the base catalog; and
a third data field indicating an evaluated list price for the object.

11. The method of claim 8, wherein the catalog schema data structure further comprises a fourth table to represent a catalog taxonomy comprising:
a first data field indicating a substantially unique identification to assign to respective objects in the base catalog;
a second data field providing a catalog name of the base catalog;
a third data field identifying a unique child ID of a child product, category, or variant;
a fourth data field specifying a child catalog name; and
wherein the substantially unique identification, the catalog name, the unique child ID, and a child catalog name, indicate a product hierarchy in the virtual catalog.

12. The method of claim 8, wherein the catalog schema data structure further comprises a fifth table for indicating pricing rules, the fifth table comprising:
a first data field for indicating a catalog name corresponding to a particular rule;
a second data field indicating an object ID of a catalog, category, product, or variant to which the particular rule applies;
a third data field identifying a rule type; and
a fourth data field specifying an amount to determine a new price for the catalog, category, product, or variant.

13. The method of claim 12, wherein the rule type comprises a percentage on/off rule, a fixed on/off rule, a set amount rule, or a no-change rule.

14. The method of claim 12, wherein the new price is based on a list price indicated in the base catalog.

15. A computing device comprising:
a processor; and
a memory coupled to the processor, the memory comprising computer-program instructions executable by the processor for generating or managing a catalog with a catalog schema data structure, the catalog schema data structure including a first table, the first table comprising:
a first data field indicating a product, category, or variant of a base catalog to include or exclude from a virtual catalog that is derived at least in part from the base catalog;
a second data field specifying an inclusion or exclusion rule to apply to the base catalog, product, category, or variant identified in the first data field; and
a third data field providing an object ID of the product, category or variant.

16. The computing device of claim 15, wherein the catalog schema data structure further comprises a second table comprising a first data field providing a reference to any dependent virtual catalog that depends on the base catalog, a dependent virtual catalog being referenced in the virtual catalog.

17. The computing device of claim 15, wherein the catalog schema data structure further comprises a third table comprising:
a first data field identifying the base catalog;
a second data field providing an object ID corresponding to an object indicated by the base catalog; and
a third data field indicating an evaluated list price for the object.

18. The computing device of claim 15, wherein the catalog schema data structure further comprises a fourth table to represent a catalog taxonomy comprising:
a first data field indicating a substantially unique identification to assign to respective objects in the base catalog;
a second data field providing a catalog name of the base catalog;
a third data field identifying a unique child ID of a child product, category, or variant;
a fourth data field specifying a child catalog name; and
wherein the substantially unique identification, the catalog name, the unique child ID, and a child catalog name, indicate a product hierarchy in the virtual catalog.

19. The computing device of claim 15, wherein the catalog schema data structure further comprises a fifth table for indicating pricing rules, the fifth table comprising:
a first data field for indicating a catalog name corresponding to a particular rule;
a second data field indicating an object ID of a catalog, category, product, or variant to which the particular rule applies;
a third data field identifying a rule type; and
a fourth data field specifying an amount to determine a new price for the catalog, category, product, or variant.

20. The computing device of claim 19, wherein the rule type comprises a percentage on/off rule, a fixed on/off rule, a set amount rule, or a no-change rule.
